(19) United States
(12) Patent Application Publication
(10) Pub. No.: US 2012/0295995 A1
(43) Pub. Date: Nov. 22, 2012

(54) Process For Making A Foam Material From An Organic Substance

(76) Inventor: Eric Vericker, Washington, IL (US)

(21) Appl. No.: 13/112,406

(22) Filed: May 20, 2011

(51) Int. Cl. C08J 9/00

(52) U.S. Cl. 521/82

(57) ABSTRACT

A foam material made from an organic fiber mixed with water and a polyurethane glue wherein after the mixture solidifies it creates the foam material. The foam material is made by a process comprising the steps of accumulating the organic fiber, grinding the organic fiber into a fibrous material, adding water to the fibrous material to create a slurry, adding the polyurethane glue to the slurry to create a glue mixture, allowing the glue mixture to expand, and allowing the glue mixture to solidify and create the foam material.

### BACKGROUND OF THE INVENTION

1. Field of the Invention

The present invention relates to a foam material that is made from an organic fiber and a polyurethane glue as a way to incorporate the organic substance into an industrial material.

2. Description of Related Art

Hardened foam materials like Styrofoam are common products used in a plethora of products ranging from florists' planter fillers and pipe insulation to coffee cups and wall insulation. The foam material is typically a lightweight, buoyant and insulating material making it well liked for construction and packaging purposes. The hardened foam is commonly made from plastic which is processed to give it its lightweight and insulating characteristics. While Styrofoam is a well used and well liked product, it is difficult to recycle unless on a very large scale. Also, it is toxic to marine life when throw away as trash becoming debris in the world's oceans.

Recently, some developments have been made to create insulating materials made from organic substances. For example, dirt, lambs wool, sawdust and straw are all currently being used in construction, by being built into walls, floors and even ceilings. While the organic substances are more environmentally friendly they are generally heavier than their inorganic counterparts. U.S. Pat. No. 4,279,958 by Abu Ahmad discloses a composite foam panel combining inorganic fibers along with organic fibers. The inorganic and organic fibers are combined in layers create a panel good for insulation and construction. Even though the panel incorporates organic materials for construction, it may be more costly to make than the inorganic alternatives.

It would be beneficial in the art to provide a foam material that uses an organic material as its primary composition material. It would also be desirable in the art to provide a foam material that is relatively simple and low-cost to construct.

### SUMMARY OF THE INVENTION

In view of the foregoing disadvantages inherent in the prior art, the general purpose of the present invention is to provide a foam material made from an organic fiber, configured to include all of the advantages of the prior art, and to overcome the drawbacks inherent therein.

Accordingly, an object of the present invention is to provide a foam material made by combining an organic fiber and a polyurethane glue.

Another object of the present invention is to provide a foam material made from an organic fiber that serves as an insulating product for construction, packing and manufacturing.

To achieve the above objects, in an aspect of the present invention, a foam material is made from an organic fiber mixed with water and a polyurethane glue wherein after the mixture solidifies it creates the foam material. The foam material is made from a process comprising the steps of accumulating the organic fiber, grinding the organic fiber into a fibrous material, adding water to the fibrous material to create a slurry, adding the polyurethane glue to the slurry to create a glue mixture, allowing the glue mixture to expand, and allowing the glue mixture to solidify and create the foam material.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a block diagram of a process of making a foam material from an organic fiber in accordance with an exemplary embodiment of the present invention.

### DETAILED DESCRIPTION OF THE DRAWINGS

The present invention relates to a foam material that is made from an organic fiber and a polyurethane glue as a way to incorporate the organic substance into an industrial material. The foam material is made by combining a ground organic fiber like cornstalk, hay or stray, water and a polyurethane glue like Gorilla Glue®. After the mixture solidifies it may be shaped and used for construction, packaging, manufacturing, insulation and the like. The foam material may be light weight, water resistant, and able to absorb extreme hot or cold temperatures. By utilizing the organic fiber, the foam material is a cost effective and environmentally friendly alternative to the Styrofoam products currently available on the market.

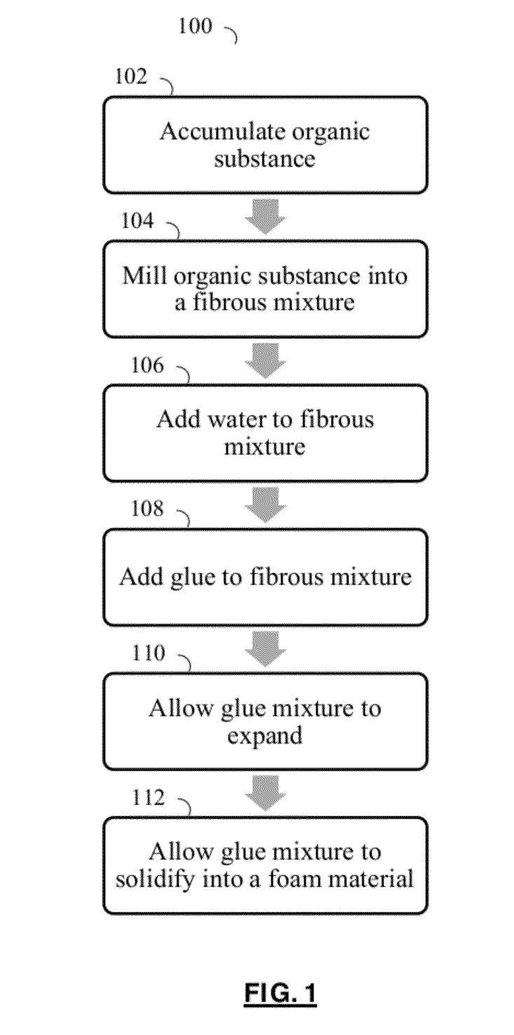

Tuning now descriptively to the drawings, referring to FIG. 1, a block diagram of a process of making a foam material from an organic fiber (100) (hereinafter the process) is shown in accordance with an exemplary embodiment of the present invention. The process (100) begins by a user accumulating an organic fiber (102). The organic fiber may be cornstalks, hay, straw, saw dust, wood chips or similar organic materials. The organic fiber may be fresh or dehydrated before use. Next, the user mills or grinds the cornstalks into a fibrous mixture (104). The user may use a blender, wood chipper or shredder, straw cutter or another machine durable and strong enough to break down the organic fiber into a fibrous mixture. The fibrous mixture may range in appearance from a powder or a woodchip pile.

Next, the user adds a portion of water to the fibrous material (106). The organic fiber absorbs the water to create a mulch or thick paste like slurry. Once the organic substance has absorbed the water, the user adds a polyurethane glue into the slurry mixture (108). The polyurethane glue may be a substance like Gorilla Glue®, Excel™ glue or another polyurethane glue currently available on the market. After mixing all of the ingredients together, the user allows the glue mixture to expand (110). The glue mixture may be placed into a pan or mold to enable the glue mixture to expand into the form of bounding structure. Finally, the glue mixture is allowed to solidify thereby creating a foam material (112).

The foam material may be a hard material, similar to Styrofoam, filled with air pockets to allow the foam material to remain light for transport and construction. After formation, the foam material may be cut or shaped to be utilized as desired by the user. The foam material is light weight, water resistant and temperature insulating so that it is able to be used in a variety of different environments and for many different purposes like construction, packaging, manufacturing and insulation. By utilizing the organic fiber, the construction of the foam material recycles the cornstalks, hay, straw and wood chips that may otherwise be used as waste products. Therefore, the foam material offers an environmentally friendly alternative to synthetic substances currently available on the market.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A process of making a foam material from an organic fiber comprising the steps of:
accumulating an organic fiber;
grinding the organic fiber into a fibrous material;
adding water to the fibrous material to create a slurry;
adding a polyurethane glue to the slurry to create a glue mixture;
allowing the glue mixture to expand; and
allowing the glue mixture to solidify and create the foam material.

2. The process of making a foam material from an organic fiber according to claim 1, further comprising the step of placing the glue mixture within a bound structure after adding the polyurethane glue.

3. The process of making a foam material from an organic fiber according to claim 1, further comprising the step of shaping the foam material for use for one of at least construction, packaging, manufacturing and insulation.

4. A foam material comprising:
an organic fiber ground into a fibrous mixture;
a portion of water added to the fibrous mixture; and
a polyurethane glue added to the fibrous mixture wherein after the polyurethane glue is added the foam material is formed.

5. The foam material according to claim 4, wherein the organic fiber is cornstalk.

6. The foam material according to claim 4, wherein the organic fiber is hay.

7. The foam material according to claim 4, wherein the organic fiber is straw.

8. The foam material according to claim 4, wherein the organic fiber is wood chips.

9. The foam material according to claim 4, wherein the polyurethane glue is Gorilla Glue®.
